(19) United States
(12) Patent Application Publication
(10) Pub. No.: US 2022/0294222 A1
(43) Pub. Date: Sep. 15, 2022

(54) ENERGY MANAGEMENT SYSTEM AND METHOD

(71) Applicant: EFLEX, INC., Apex, NC (US)

(72) Inventors: Andrew Nicholas Winter, Chapel Hill, NC (US); Trevor Gustov Frank, San Jose, CA (US)

(73) Assignee: EFLEX, INC., Apex, NC (US)

(21) Appl. No.: 17/693,564

(22) Filed: Mar. 14, 2022

Related U.S. Application Data
(60) Provisional application No. 63/207,657, filed on Mar. 12, 2021.

(51) Int. Cl. H02J 3/14; H02J 13/00

(52) U.S. Cl. CPC H02J 3/144; H02J 13/00001; H02J 13/00002; H02J 2310/14; H02J 2310/60; H02J 2300/24; H02J 2300/40

(57) ABSTRACT

The energy management system and method provide for the control of electrical loads within a group. The group of electrical loads are prioritized in terms of importance or criticality to remain electrically connected. Prioritization can be received as rankings input by the user or as a set of rankings generated by a learning-based artificial intelligence system. One or more energy-related goals are input, with the one or more energy-related goals including at least one energy-related parameter. The one or more energy-related goals may be received as input from the user through a user interface, using, for example, a sliding controller displayed to the user on the user interface. Energy consumption of each of the electrical loads in the group is monitored, and at least one lowest ranked electrical load is disconnected when the monitored energy consumption deviates from the one or more energy-related goals.

### CROSS-REFERENCE TO RELATED APPLICATION

This application claims the benefit of U.S. Provisional Patent Application No. 63/207,657, filed on Mar. 12, 2021, which is hereby incorporated by reference in its entirety.

### BACKGROUND

### 1. Field

The disclosure of the present patent application relates to managing energy consumption and production in a group of electrical loads, and particularly to the prioritized disconnection or shedding and/or reconnection of individual electrical loads to meet pre-defined energy-related goals based on inputs and/or measurements with or without further data processing.

### 2. Description of the Related Art

So-called “smart meters” are well known and are readily available to consumers. A typical smart meter is an electronic device that records basic power information, such as consumption of electric energy, voltage levels, current, and power factor. Typical smart meters communicate the information to the consumer to indicate consumption behavior, as well as duplicating the function of a conventional utility power meter. Although smart meters and similar devices, such as home energy monitors, provide consumers with indications of where energy can be saved, how energy costs can be lowered, etc., the actual implementation of any energy saving plan must be performed manually. In other words, although a smart meter may provide an indication of which electrical devices in a home draw the most power or get the most usage, it is up to the user to manually disconnect the device, or limit its usage, in order to conserve electricity with respect to rate structure.

In addition to the manual disconnection by the user described above, smart meters, home energy monitors and the like only provide information directly related to power consumption without any further considerations, such as how that power consumption translates into actual costs. Further, such smart meters and the like are adapted solely to measure power consumption from the conventional utility grid and are not easily integrated into systems which include an alternative power supply, such as, for example, solar panels or wind turbines. Thus, an energy management system and method solving the aforementioned problems are desired.

### SUMMARY

The energy management system and method provide for the control of electrical loads within a group and/or overall energy consumption based on pre-defined energy-related goals, which may be based on inputs and/or measurements, with or without further data processing, and may further be adaptive. The electrical loads in the group of electrical loads are prioritized in terms of importance, criticality or user-defined goals to remain electrically connected. Prioritization can be received as rankings input by the user or as a set of rankings generated by a learning-based artificial intelligence system, providing an adaptive architecture for defining goals and/or rankings. One or more energy-related goals are received, with the one or more energy-related goals including at least one energy-related parameter. The one or more energy-related goals may be received as input from the user through a user interface, using, for example, a sliding controller displayed to the user on the user interface. Energy consumption, as well as any other desired energy line characteristics, of each of the electrical loads in the group is monitored, and at least one lowest ranked electrical load is disconnected when the monitored energy consumption (or other energy line characteristics) deviates from the one or more energy-related goals.

With regard to the artificial intelligence learning-based embodiment, rather than basing disconnection or shedding on real time monitoring, or in addition to real time monitoring, the disconnection or shedding of electrical loads may be based on learned behavior, including, but not limited to, a predicted load distribution or balance, load output based on environmental factors, such as weather or irradiation, in view of historical data for these parameters, time of the day, day of the year, month or season, predicted rolling blackouts based on these or other factors, market dependence, market energy prices, market energy rates, and the like.

Non-limiting examples of energy-related parameters that may be used herein include, but are not limited to, time of use-related expenses, energy demand-related expenses, overall average energy expenses, and combinations thereof. Additionally, the group of electrical loads may be connected to an alternative source of energy, such as a generator, a solar power system, an energy storage device, such as a storage battery, or the like. Thus, the at least one energy-related parameter may be expanded to incorporate parameters related to the connected alternative source of energy. Non-limiting examples of such parameters related to the connected alternative source of energy include average energy exported to an electrical grid from the alternative source of energy, average battery charge time, battery charge level, average battery discharge rate, peak battery discharge rate, battery life, generator run time, remaining fuel level, peak energy, average available energy, and combinations thereof. Additionally, the system may be used to manage the group of electrical loads and the at least one alternative source of energy to prevent an overload state in the at least one alternative source of energy. The system may also be used to control an amount of energy exported from the alternative source of energy to the electrical grid.

When at least one energy storage device, such as a battery or the like, is also connected to the group of electrical loads, the system may periodically charge the energy storage device for routine charging thereof and/or to determine one or more performance-related parameters of the energy storage device.

Additionally, at least one external parameter may be monitored for adjusting at least one operational parameter of at least one of the electrical loads based on the at least one external parameter. As a non-limiting example, one or more sensors may be provided for measuring the ambient temperature, and control over a set point for an air conditioner, heating system, water heater or the like may be controlled based on the measured temperature, thus reducing the load without necessarily disconnecting the load.

In an alternative embodiment, a plurality of loads connected to both the electrical grid and an alternative source of power can be managed. Upon detection of a predetermined condition (e.g., a blackout, a brownout, an environmental condition, etc.), a user-defined sub-set of the electrical loads may be disconnected from the electrical grid. It should be understood that the sub-set of the electrical loads may include anywhere between one selected load and all of the loads. Additionally, in response the detection of the predetermined condition, at least one of the electrical loads from the user-defined sub-set of the electrical loads may be connected to an alternative source of power (e.g., solar power, wind power, battery backup power, etc.). It should be understood that the number of electrical loads from the sub-set which are reconnected to the alternative source of power is user-selected and may be anywhere between a single one of the loads contained in the sub-set and all of the loads contained in the sub-set.

These and other features of the present subject matter will become readily apparent upon further review of the following specification.

### BRIEF DESCRIPTION OF THE DRAWINGS

FIG. 1 is a block diagram showing system components of an energy management system.

FIG. 2 is a block diagram showing components of a control system of the energy management system.

FIG. 3, FIG. 4, FIG. 5, FIG. 6, FIG. 7, FIG. 8, FIG. 9, FIG. 10 and FIG. 11 are screenshots of a user interface of the energy management system.

FIG. 12 is a block diagram showing system components of an alternative embodiment of the energy management system.

Similar reference characters denote corresponding features consistently throughout the attached drawings.

### DETAILED DESCRIPTION OF THE PREFERRED EMBODIMENTS

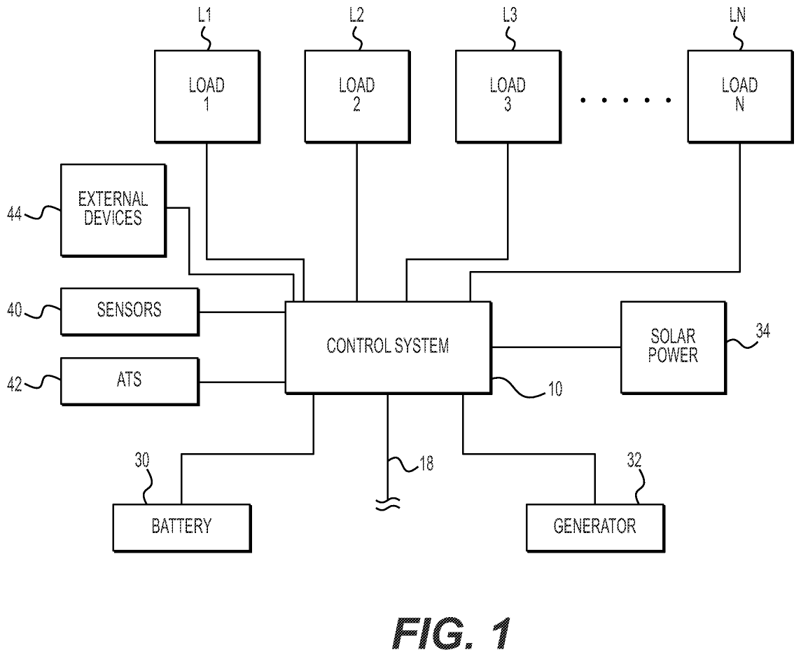

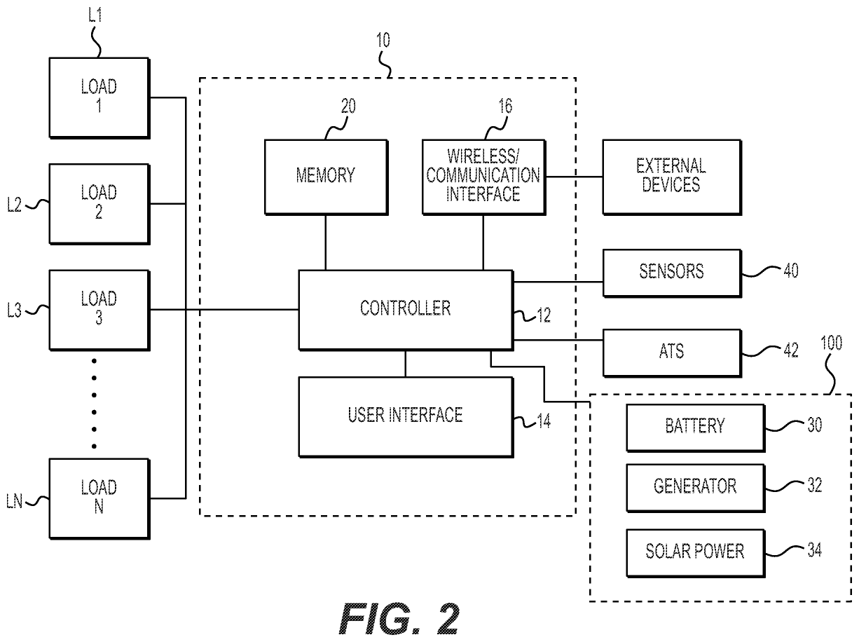

As shown in FIGS. 1 and 2, the energy management system includes a control system 10 adapted for connection with N electrical loads L1, L2, L3, . . . , LN, where it should be understood that N represents an arbitrary number of electrical loads within a particular group. As will be discussed in greater detail below, in addition to conventional electrical loads L1, L2, L3, . . . , LN, loads constituting, or at least partially including, one or more supply grids are also contemplated, such as, but not limited to, storage batteries, inverters, etc. As a non-limiting example, the N electrical loads L1, L2, L3, . . . , LN may include any critical and/or non-critical electrical appliances and devices powered by the electrical grid within a household or small commercial business. In FIG. 1, line 18 represents a connection to the electrical grid, although it should be understood that control system 10 may be interconnected between loads L1, L2, L3, . . . , LN and any suitable source of electrical power.

It should be understood that additional sources of power and/or storage may also be connected to the electrical grid ultimately through line 18, such as, for example, a storage battery 30, a generator 32, and a solar power system 34, as illustrated in the non-limiting example of FIG. 1. It should be further understood that the N electrical loads L1, L2, L3, . . . , LN are not limited to any particular type of electrical loads, and may be any type of electrical load. Non-limiting examples of such loads include electric vehicles, HVAC systems, stoves, water heaters and the like.

As shown in FIG. 2, control system 10 includes at least one controller 12, which operates on software, programming, or the like to provide monitoring and management of the attached energy loads L1, L2, L3, . . . , LN based on pre-configured and periodically captured information inputs to achieve the user's desired energy consumption and system goals. As will be discussed in greater detail below, programmable data, input parameters and the like may be entered through any suitable type of user interface 14, and may be stored in memory 20, which may be any suitable type of computer readable and programmable memory and is preferably a non-transitory, computer readable storage medium. Calculations and program operations are performed by controller 12, which may be any suitable type of computer processor and may be displayed to the user via user interface 14 or a separate display. As a non-limiting example, user interface 14 may be a touchscreen or the like. A wireless interface 16 may also be provided for wireless communication with remote systems or remote controllers. Although FIG. 2 illustrates a simplified direct feed from each load L1, L2, L3, . . . , LN into controller 12, it should be understood that this is for purposes of illustration only, and that any suitable type of interfaces, circuitry, buses, meters, monitors or the like may be provided for controller 12 to monitor and control the power consumption of each load L1, L2, L3, . . . , LN.

It should be understood that communication between controller 12 and each electrical load L1, L2, L3, . . . , LN, as well as additional sources of power and/or storage, such as, for example, storage battery 30, generator 32, and solar power system 34, as well as any other devices desired to connect with controller 12, may be implemented using any suitable type of communication, such as, for example, the integrated communication systems and protocols found in commercially available Internet-of-Things (JOT) devices, devices adapted for communication with cloud-based storage and control, and devices adapted for communication with app-based control, as well as conventional wireless and wired communication protocols, such as Wi-Fi, Bluetooth®, ethernet, Zigbee®, RS-232, RS-485, cellular communication and the like.

In FIGS. 1 and 2, control system 10 is shown in communication with one or more external devices 44 through communication interface 16. It should be understood that controller 12 may communicate with, receive data from, send data to, and/or control any suitable type of external device adapted for communication. Non-limiting examples of such external devices 44 include virtual assistant devices, security systems, thermostats and IOT devices. Further, controller 12 may also issue control signals indirectly through, or receive data indirectly from, a secondary control/data device. As a non-limiting example, external devices 44 may include a home virtual assistant which is itself already integrated into a home network of electrical appliances and devices. In this example, the home virtual assistant may already control home appliances such as lights, fans, etc., and may also already receive data from smart appliances which measure things like temperature, power consumption, etc. Controller 12 may control operation of these external devices 44, and also receive data therefrom, through the home virtual assistant.

It should be understood that controller 12 may incorporate, or be connected to, any suitable type of monitors or meters, such as, but not limited to, meters adapted for monitoring electrical current, voltage (L1, L2, L3), phase angle/power factor, frequency and waveform. The monitors or meters may include, or be integrated with, the current transformers of solar power system 34, battery 30, the individual electrical loads, etc. Further, as will be discussed in greater detail below, controller 12 may disconnect or shed individual loads, or limit power thereto, thus it should be understood that controller 12 may incorporate, or be connected to, any suitable devices for performing disconnection or power control. Non-limiting examples of such devices include current-limited contactors, current-controllable inverters, current-controllable energy modules (and/or modules affixed with current-limited and/or controllable output), and the like, allowing for the control of one or more electrical loads by modulating or interrupting electrical current between the loads and their respective protective breakers.

Controller 12 may be associated with, or incorporated into, any suitable type of computing device, for example, a personal computer or a programmable logic controller. The user interface 14, the controller 12, the wireless interface 16, the memory 20 and any associated computer readable recording media are in communication with one another by any suitable type of data bus, as is well known in the art. Examples of computer-readable recording media include non-transitory storage media, a magnetic recording apparatus, an optical disk, a magneto-optical disk, a memory card, an SD card, and/or a semiconductor memory (for example, RAM, ROM, etc.). Examples of magnetic recording apparatus that may be used in addition to memory 20, or in place of memory 20, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

Through user interface 14, the user may assign load priority to each load L1, L2, L3, . . . , LN, or to a group of the loads. As an alternative to the manual input of such load priority, controller 12 may run artificially intelligent software which monitors, over time, the user's preferences, the actual on-off state of each load, and energy use behavior and patterns and, using this monitoring data, which is received over time, learns which loads are used and/or prioritized most, thus automatically developing a priority ranking for the loads. This automatically developed priority ranking would then be input to assign load priority to each load L1, L2, L3, . . . , LN, or to a group of the loads. Thus, either through manual input or through input by artificial intelligent learning (or a hybrid of both), individual loads or groups of loads can be assigned a priority ranking. It should be understood that any suitable type of learning-based artificial intelligence system may be used to monitor a user's manual input over a period of time and/or to monitor the user's preferences, the actual on-off state of each load, and energy use behavior and patterns in order to generate the prioritized ranking.

As a non-limiting example, a maximum energy state or condition can be defined when all loads L1, L2, L3, . . . , LN are connected and able to consume electrical power. A first reduced energy state or condition can then be achieved by controller 12 disconnecting power to the lowest ranked load (or group of loads). A second reduced energy state or condition can be achieved by controller 12 disconnecting power to the next lowest ranked load (or group of loads), etc. This can be followed all the way to a minimum energy state or condition, where all loads (except any loads with a critical “always on” rating) are disconnected.

As a non-limiting example, considering a typical household with a wide variety of electrical loads, typical “always on” electrical loads (e.g., any or all of refrigerators, freezers, alarm systems, lighting, etc.) may remain connected to the electrical grid in the typical manner (i.e., using conventional circuits, circuit control system, circuit breakers, etc.). A selected group of electrical loads, however, may be controllable using the present system, with this selected group of non-critical loads having their electrical connections intercepted by control system 10 just behind the corresponding circuit control system(s) and before the particular load. By way of non-limiting example, if the circuit control system is a circuit breaker, this may be implemented right in the circuit breaker box (or a specialized circuit breaker box which incorporates an integrated control system 10). Any suitable type of contactors, circuits, interfaces, etc. may be used to connect control system 10 between the load(s) and the external power supply (i.e., connection to the grid through line 18).

As another non-limiting example, sensors, smart meters, or the like may be connected to the loads L1, L2, L3, . . . , LN to measure the respective operational currents (in real time) of the loads. The controller 12 is either in communication with the sensors, smart meters or the like, or incorporates them as part of an integrated control unit. When the measured current(s) exceed the predetermined goal (which may be based on a number of different factors), controller 12 generates signals which control current interrupters or the like to disrupt the lowest ranked one(s) of the loads L1, L2, L3, . . . , LN. Controller 12 is programmed to activate the current interrupters or the like to shed the loads in a predetermined sequence based on the prioritized ranking. After shedding sufficient loads to reduce the overall current to a point equal to or less than the predetermined peak total current (based on the particular goal(s) of the user), controller 12 then determines whether any of the loads which have been shed can be restored to operation without exceeding or deviating from the set goal(s). If so, that load is automatically restored to operational status.

It should be understood that any suitable type of circuit interrupter, circuit breaker, transformer, inverter or the like may be used to temporarily shed, or limit power to, the lowest ranked load(s). Similarly, it should be understood that controller 12 may communicate with these devices using any suitable type of interfaces, buses, switches, communication lines, etc. Controller 12 is adapted to transmit any suitable type of control signal to the circuit interrupter or the like, or to any associated circuits or devices associated therewith, to initiate the temporary shedding or power limiting thereof. Further, in addition to shedding or limiting power, it should be understood that any suitable type of circuit, device or the like may also be used to increase power to one or more loads from an alternate power source, such as battery 30; e.g., battery 30 may be used as part of an energy arbitrage strategy, with controller 12 increasing output of battery 30 to one or more loads in order to reduce the cost of energy obtained from the electrical grid.

In addition to full disconnection, it should be understood that controller 12 may also be used to change or augment the settings on particular ones of the electrical loads L1, L2, L3, . . . , LN. As a non-limiting example, one or more sensors 40 may be connected to control system 10, and the one or more sensors 40 may include a temperature sensor, such as a thermostat, thermocouple or the like. Controller 12 of control system 10 may be used to automatically change the set point on a temperature-dependent load in this example, such as a heating system, cooling system, water heater, etc. Thus, the user-defined or artificial intelligence-defined goals may be achieved through feedback from the one or more sensors 40, and do not necessarily have to involve a complete disconnection of loads. It should be understood that the one or more sensors 40 may be any suitable type of sensors and may measure any desired parameters. Non-limiting examples include temperature, solar-related parameters for solar power system 34 (e.g., light intensity, wavelength distribution, cloud coverage, etc.), atmospheric pressure, humidity, dew point, etc.

With regard to the artificial intelligence learning-based embodiment, rather than basing disconnection or shedding on real time monitoring, or in addition to real time monitoring, the disconnection or shedding of electrical loads L1, L2, L3, . . . , LN may be based on learned behavior, including, but not limited to, a predicted load distribution or balance, load output based on environmental factors, such as weather or irradiation, in view of historical data for these parameters, time of the day, day of the year, month or season, predicted rolling blackouts based on these or other factors, market dependence, market energy prices, market energy rates, and the like.

Through user interface 14, the user may program controller 12 to consider a wide variety of user goals and scenarios. As a non-limiting example, the user may wish to reduce time of use (TOU) related expenses. When selecting this goal, controller 12 may perform the necessary calculation to disconnect or connect loads according to the prioritized ranking discussed above in order to achieve the input desired average energy rate. Returning to FIG. 1, alternate sources of power may be considered, such as one or more connected batteries 30, one or more generators 32, one or more solar panels 34, or the like, or any combination thereof. Controller 12 may be programmed to consider all available sources of power and, in order to meet the input desired average energy rate, controller 12 also has the option of taking part or all of the system “off grid” (i.e., disconnecting from the electrical grid) to operate from one or more of the local power sources 30, 32, 34 for a desired period of time. Controller 12 may control the balance of power drawn from the grid in view of the power drawn from the alternative local power sources 30, 32, 34 (i.e., operate in a balanced or controlled hybrid configuration) and/or may control how much power is returned to the grid (i.e., control energy exported from the local power sources back to the grid).

As further non-limiting examples, controller 12 may perform the necessary calculations to disconnect loads according to the prioritized ranking discussed above, or to go off grid, in order to achieve an input desired demand charge reduction, or an input desired average energy savings. As a further non-limiting example, in the case where solar power system 34 and/or a generator 32 is producing excess power, controller 12 may perform the necessary calculations to go on and off grid based on an input desired average energy export value. As an additional non-limiting example, where the system includes at least one battery 30, controller 12 may perform the necessary calculations to disconnect loads according to the prioritized ranking discussed above in order to attempt to achieve an input desired average battery charge time, which is typically subject to a maximum allowable charge rate while not exceeding the user's desired grid power consumption. The battery charge can be achieved using energy received from the energy grid, the solar power system 34, the generator 32, or any combination thereof.

As noted above, the system may limit, set or restrict the export or back-feeding of energy to the electrical grid, thus allowing a safe means of installing more solar capacity than would typically be allowed by the interconnected utility grid. Typically, only 20% of the system main breaker is allowed to be exported or back-fed, however, by limiting the back-feed current in a controlled and programmable manner, this 20% restriction to the utility grid can be met while allowing a much higher actual number of installed solar panels without an additional risk to the utility grid, thus providing a benefit to homeowners and small businesses, for example, who may wish to install more solar panels to meet more of their energy needs using solar power.

Similarly, controller 12 may be programmed to operate in a fully off grid mode. Thus, as a non-limiting example, controller 12 may perform the necessary calculations to disconnect loads according to the prioritized ranking discussed above in order to achieve an input desired battery life. The user may input, or the controller 12 may otherwise collect, data regarding the battery charge state and size, the maximum battery discharge rate, etc. in order to properly calculate the load requirements for battery usage and/or charging. Similarly, as another non-limiting example, controller 12 may perform the necessary calculations to disconnect loads according to the prioritized ranking discussed above in order to achieve an input desired generator run time. The user may input, or the controller 12 may otherwise collect, calculate and/or predict, data regarding the generator fill level, generator size, maximum generator kW rating, etc. in order to properly calculate the load requirements for generator operation. As discussed above, one or more sensors 40 may be employed to, for example, monitor generator parameters. These parameters may also be manually input or learned by the artificial intelligence system.

As a further off grid non-limiting example, controller 12 may perform the necessary calculations to connect or disconnect loads according to the prioritized ranking discussed above in order to achieve a desired input average maximum available energy, subject to battery, solar and generator hard limits, e.g., battery discharge rate, generator maximum kW rating, etc. As an additional non-limiting example, if solar production exceeds energy consumption within the system, controller 12 may perform the necessary calculations to disconnect loads according to the prioritized ranking discussed above in order to achieve the desired input battery charge time. It should be understood that in off grid mode (or a hybrid mode), controller 12 also performs the same functions as in on grid mode; i.e., regardless of the power source for the electrical loads L1, L2, L3, . . . , LN, controller 12 may connect or disconnect loads according to their prioritized ranking in order to reduce or increase energy based on the energy-related goals. However, regardless of whether system is on grid, off grid or in a hybrid mode, controller 12 may further disconnect the alternative energy sources and/or energy storage systems.

As a non-limiting example, controller 12 may disconnect battery 30 from the electrical loads in order to allow it to charge from a selected power source (e.g., solar power system 34, generator 32, or the electrical grid). Controller 12 may control which loads are served by a particular power source; e.g., battery 30 could be charged by generator 32 while selected ones (or all) of the electrical loads are powered by the electrical grid. As a non-limiting example, controller 12 could implement A×B full matrix switching where any number of energy sources A could be matrixed to any number of loads B in any singular or plural fashion (i.e., a so-called “full” matrix capability).

The above examples allow the energy management system to act as a microgrid and/or virtual power plant (VPP). Additionally, this allows the system to be started without externally supplied power (i.e., a “black start”), as well as providing further capability to respond to inputs from third-party microgrids and/or grids and/or VPPs. Additionally, controller 12 may act to control energy exported from the microgrid and/or VPP back to the electrical grid, including, but not limited to, adding electrical loads to limit how much power is exported. Controller 12 may also be used, as non-limiting examples, to manage voltage and coordinate loads and energy production across the microgrid and/or VPP and the connection to the electrical grid, implementing Active Grid Management (AGM). In the non-limiting example of FIG. 2, battery 30, generator 32 and solar power system 34 are shown making up a microgrid or VPP 100, which is under the control of control system 10.

The establishment of a microgrid and/or VPP, either alone or in combination with another connected microgrid and/or VPP, may also be used, as non-limiting examples, to lift a sagging electrical grid, prepare/balance backup storage power, dynamically balance generation and consumption by the electrical loads, and provide for the quantification, tracking, reporting, selling, trading and buying of energy units via tokens, currency, other securities or the like.

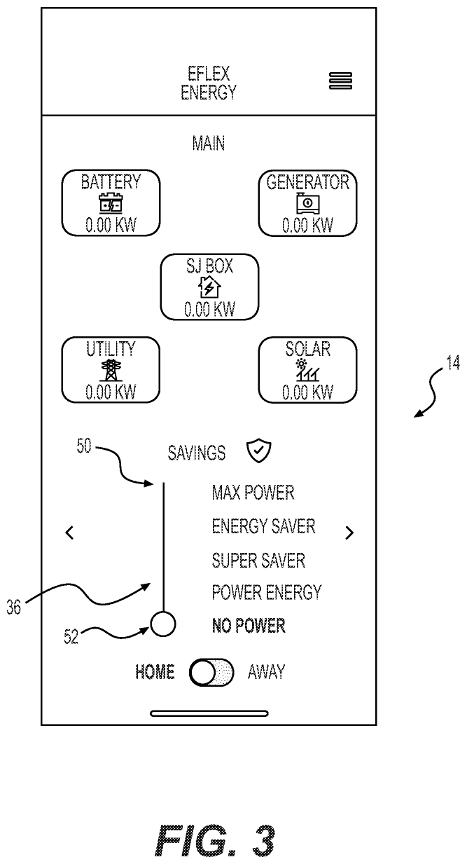

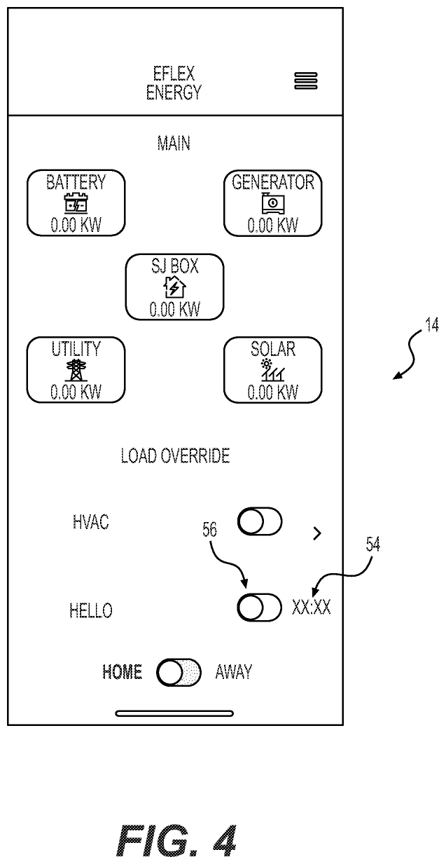

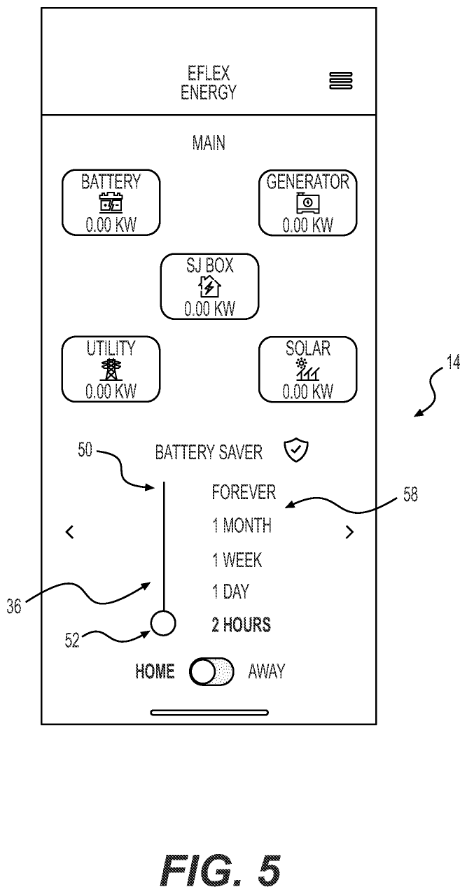

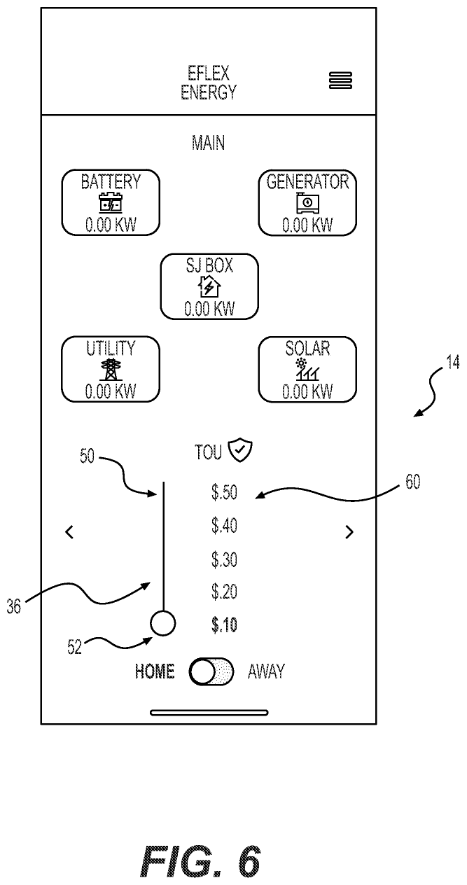

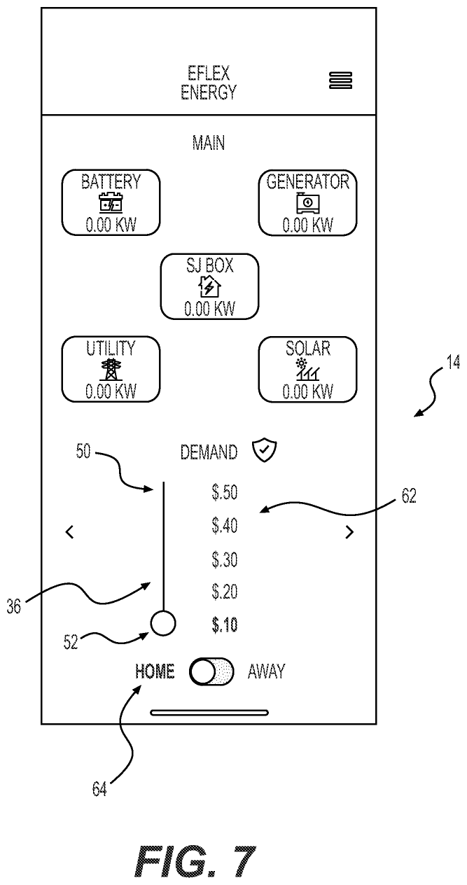

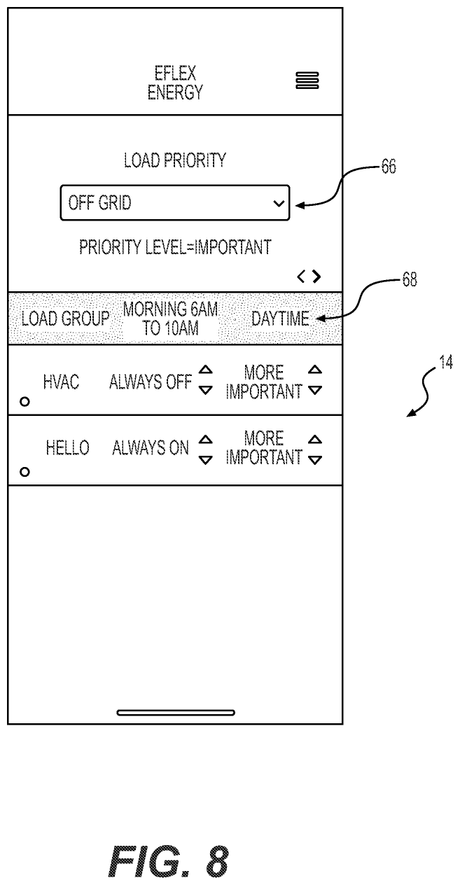

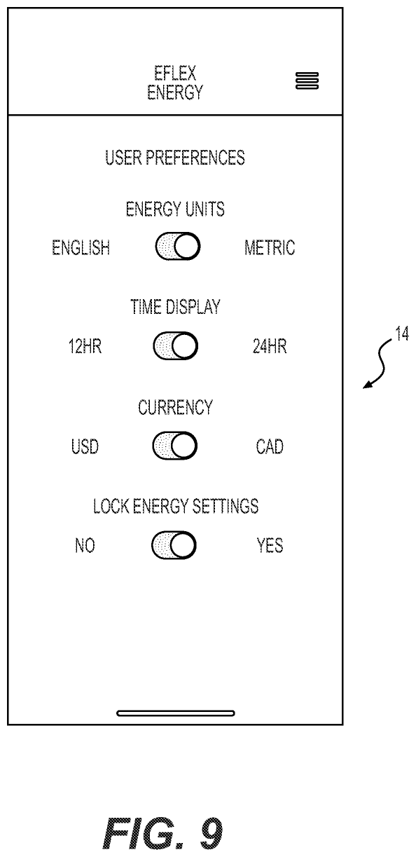

FIG. 3 shows an exemplary screenshot of an operating display of user interface 14, which may be a touchscreen or the like. As shown, the assignment of a load priority for each load or load group or the operating mode may be selected through a “slider” control 36 displayed to the user. This visual controller 36 may be operated manually or automatically by the software application, and in both cases will update and show the current operating mode or status. It should be understood that the displays of FIGS. 3-11 are shown for exemplary purposes only. In the example of FIG. 3, a “high” energy setting is indicated generally as 50 and a “low” energy setting is indicated generally as 52. Thus, the user may slide the sliding control 36 upward to increase desired energy use, and slide the sliding control 36 downward to decrease desired energy use. In the “low” energy configuration shown in FIG. 3, only critical loads are connected. It should be understood that any suitable type of controls and/or user interface may be used, and that displays of FIGS. 3-11 are shown for exemplary purposes only. As a non-limiting example, rather than a touchscreen display, the controls could be purely analog controls, or analog controls combined with digital controls, including, but not limited to, analog switches, knobs, variable resistors and the like.

In addition to the exemplary control goals and modes discussed above, the user may also enter a wide variety of other parameters for controller 12 to consider in its calculations and operations. As non-limiting examples, such parameters may include time, system state (e.g., attached to an active electrical utility grid, attached to an active solar system or battery system, not attached to an active electrical utility grid, etc.), occupancy state (e.g., “home” or “away”), local current or predicted weather conditions, local or predicted utility conditions, instructions received from a utility or other third party, etc. As a further non-limiting example, controller 12 may be programmed to prevent overloading of an attached energy source (e.g., solar power system 34, battery 30, etc.) by limiting maximum energy demand within a response time frame to provide such protection effectively, wherever possible. Similarly, as another non-limiting example, controller 12 may be programmed to manage the connected loads to prevent discharging attached energy storage (e.g., battery 30) too rapidly, which may cause damage or reduce storage component life. Thus, controller 12 may act as a battery asset manager to reduce battery degradation. Further, when implementing the artificial intelligence system, battery asset management may be at least partially based on learned historical data.

As discussed above, controller 12 may include, or may be separately connected to, any suitable type of meters or monitors for providing real-time energy information associated with the loads and any additional connected sources of power. It should be understood that communication with such meters or monitors may be implemented using any suitable type of communication system or protocol, such as the on-board communication equipment installed in conventional Internet-of-Things (IOT) devices, Wi-Fi wireless communication, the RS-485 communication standard, application programming interfaces (APIs), etc.

Additionally, although the simplified diagram of FIG. 2 illustrates only a single controller 12, it should be understood that a controller 12 may operate on its own, or may operate in conjunction with any suitable number of “slave” devices or circuits in communication with controller 12. It should be understood that any suitable configuration or architecture for such slave devices may be used, such as a hive, an ad hoc network, a coordinated network or the like. Additional hardware arrangements will be discussed in greater detail below. Further, as discussed above, controller 12 may be in communication with a wireless interface 16, allowing for remote control and programming of controller 12. It should be understood that wireless interface 16 may be replaced by, or used in conjunction with, wired communication. It should be further understood that controller 12 is not required to operate locally with respect to loads L1, L2, L3, . . . , LN. Controller 12 may be remote with respect to loads L1, L2, L3, . . . , LN, or may be used in conjunction with a control-level server or system which is located remotely, such as, for example, the control-level servers or systems which are used to coordinate conventional Internet-of-Things (IOT) devices.

FIGS. 4-11 show a variety of further exemplary screenshots. As noted above, the displays illustrated in FIGS. 3-11 are shown for exemplary purposes only. The non-limiting example of FIG. 4 shows exemplary controls allowing the user to override the programmed load prioritization as well as manually set the exemplary geofencing states “home” and “away”. In this exemplary display, the loads included in the display can be selected to be included in the set of loads for prioritization. In the example of FIG. 4, the virtual button 56 indicates whether the override is set to on or off. When the override is on, a time display 54 may be presented to indicate to the user how much time remains until the override is over.

FIG. 5 illustrates the exemplary slider control 36 in the context of a battery life control. In the example of FIG. 5, display portion 58 indicates the runtime of battery 30 when the system is off grid. In such a condition, controller 12 will reduce the load and/or battery demand to meet the slider setting 36 based on instantaneous and predicted loads.

FIG. 6 illustrates the exemplary slider control 36 in the context of a time of use (TOU) control for inputting desired energy usage by cost. In the example of FIG. 6, display portion 60 shows a listing of exemplary TOU rates. Both TOU and tiered rates may have a separate display screen for entry of the particular rate details, such as, for example, cost/kW, the time(s) each rate is active, the kWh amount and cost, the seasonal rate, etc. The user may also choose whether these details are populated/updated by controller 12, by manual input from the user, or from a third-party system. In the configuration of exemplary FIG. 6, controller 12 will reduce loads and optimize energy arbitrage of battery 30 (or other storage devices) to maintain the cost per kWh at or below the setting of slider control 36.

FIG. 7 illustrates the exemplary slider control 36 in the context of input energy demand cost. In the example of FIG. 7, button 64 allows the user to set the “home” or “away” mode manually. Alternatively, this may be set through geofencing of one or more users. Users have a priority mode in the load priority-setting table. Display area 62 shows demand charges, where controller 12 measures the kWh used over a particular demand time (e.g., 15 minutes) and adds or subtracts power as required to maintain a desired rate over this particular demand time. Controller 12 will reduce loads or add power from battery 30, generator 32, solar power system 34, etc. to ensure the demand charge is at or below the setting of slider control 36.

FIG. 8 illustrates an exemplary screen for manually setting priority of individual loads. In exemplary FIG. 8, example display area 66 may display “ON GRID”, “OFF GRID”, “ON GRID AWAY”, or “OFF GRID AWAY”. With regard to display area 68, in this example, when the TOU or tiered rate is selected, the TOU or tiered rate structure will also be the load priority times.

FIG. 9 illustrates an exemplary screen for setting desired display units. FIG. 10 illustrates an exemplary system configuration screen. In exemplary FIG. 10, selection of display/choice area 70 affects what is available for selection in the analog inputs of FIG. 11. As discussed above, the display of FIG. 10 is for exemplary purposes only. As an alternative, for example, the selections illustrated in FIG. 10 could be replaced with drop-down selections. The properties displayed in this screen could further be automatically populated through connection with the particular loads and power sources.

FIG. 11 illustrates an exemplary screen for inputting parameters associated with additional equipment (e.g., solar power system 34, generator 32, etc.). In exemplary FIG. 11, column 72 shows the CT current rating. It should be understood that the values displayed in column 72 are shown for exemplary purposes only. As a non-limiting example, full scale analog voltage is typically 0.33 VAC. If 25 A is selected, the analog voltage is 0.03 VAC RMS, resulting in a current of 2.5 A. In column 74, the displayed channels may only be available if selected in the system configuration. Any spare channels may be named anything by the installer. One or more channels may be reserved to read voltage, typically through an isolation transformer scaled down to ±0.33 VAC. Column 76 shows the current reading, based on the amp rating and voltage. In the example of FIG. 11, column 78 shows the actual analog voltage reading for a debugging configuration.

In addition to the above, controller 12 may communicate with external systems, either through wireless interface 16 or a wired connection, in order to, for example, issue and/or receive commands and data to/from third-party devices, such as inverters, battery management systems, solar module monitors and controllers, electric vehicles and their chargers and smart meters, etc.

Additionally, controller 12 may be programmed to periodically charge attached energy storage (e.g., battery 30) to determine charge capacity, degradation, and other performance parameters to inform the system and third-parties, such as installers, storage suppliers, or storage manufacturers, as to system state and performance. Controller 12 may also periodically charge cycle attached energy storage (e.g., battery 30) to keep the storage exercised, extend or improve storage performance, or to better comply with the manufacturer's suggested operating instructions; i.e., as discussed above, controller 12 may also perform the functions of a battery asset manager. Controller 12 may also receive input regarding ambient temperature and/or other parameters to actively manage the charge point, charge rate, discharge rate, battery voltage, battery temperature and the like of attached energy storage (e.g., battery 30) to avoid unfavorable or dangerous operating modes and/or temperatures for the storage, including actively managing charging and, when needed, discharging of the attached storage.

Thus, as a further non-limiting example, controller 12 may integrate, or be connected to, additional sensors, such as sensors 40, which may be used for measuring temperature, voltage, current pressure, environmental data and the like.

It should be understood that the additional sensors 40 may be integrated with controller 12 as part of a main control board, for example, or may be modularly or otherwise connected to controller 12 as separate modules or boards. Additional data may be provided through the data already available to conventional IOT devices, such as, for example, the weather services typically supplied to virtual assistants and the like, and may be further provided by any suitable additional sensors or the like which may be integrated into the system, such as wireless sensors designed for integration into ad hoc wireless networks, for example.

Through wireless interface 16, or via an alternative wired interface, multiple users may communicate with controller 12, either individually or in parallel, including third parties, utilities, grid managers and/or operators. Controller 12 may send updates about system states, performance, control, alerts, or other parameters to any or all users, either upon request or at specified intervals.

Further, it should be understood that the control system 10 may operate under, or participate in, any required or desired private or public interconnection agreements, such as those required to be in compliance with local energy regulation requirements, or to be in compliance with other applicable governing requirements, such as UL 1741, SGIP and/or Rule 21. However, noting that UL 1741, SGIP and Rule 21 are each related to inverters, it should be understood that controller 12 may be connected to and control an automatic transfer switch (ATS) 42 to serve as a load manager for controlling devices and systems which consume power but are not inverters.

It should also be understood that control system 10 is not limited to any particular hardware implementation or location. As a non-limiting example, control system 10 may be attached to a panelboard or other electrical enclosure containing other energy monitoring or management components, either with or without an integrated cover, and/or control system 10 may be field-wired to such an existing panelboard, either with or without an integrated cover. As discussed above with regard to the additional sensors, it should be understood that any additional components, including sensors, communication interfaces, contactors, etc. may be integrated with controller 12 as part of a main control board, for example, or may be modularly or otherwise connected to controller 12 as separate modules or boards.

Additionally, either through wireless interface 16, wired interface, or any other suitable means of communication, controller 12 may communicate with other devices, such as connected Internet-of-Things (JOT) devices, in order to create additional functionality accessible through controller 12 and user interface 14. It should be further understood that the wireless or wired communication allows for communication of other data and information with users and/or third parties. Non-limiting examples of such communications include system and product data not limited to energy usage, attached load performance data, or any other system parameter and/or offers for products and services delivered within or outside of the system based on system data.

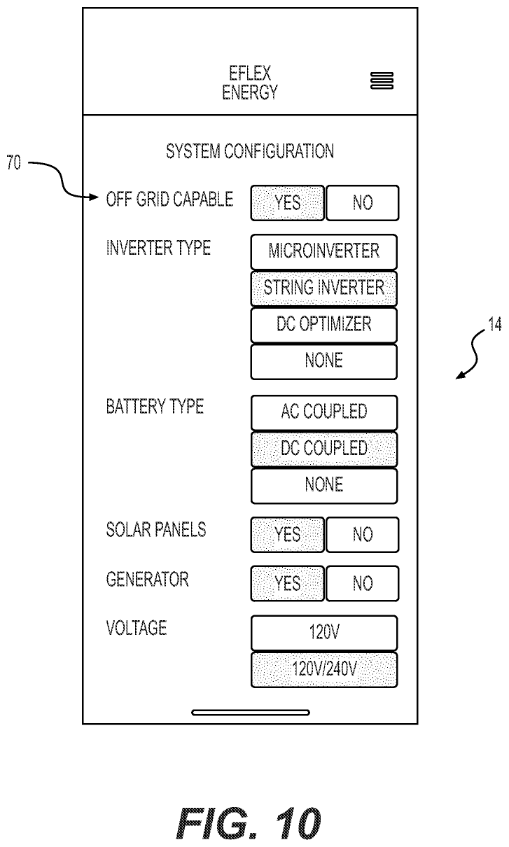

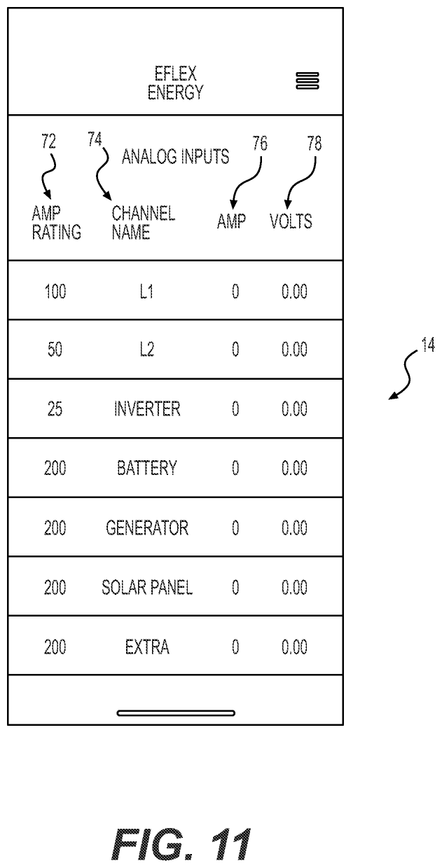

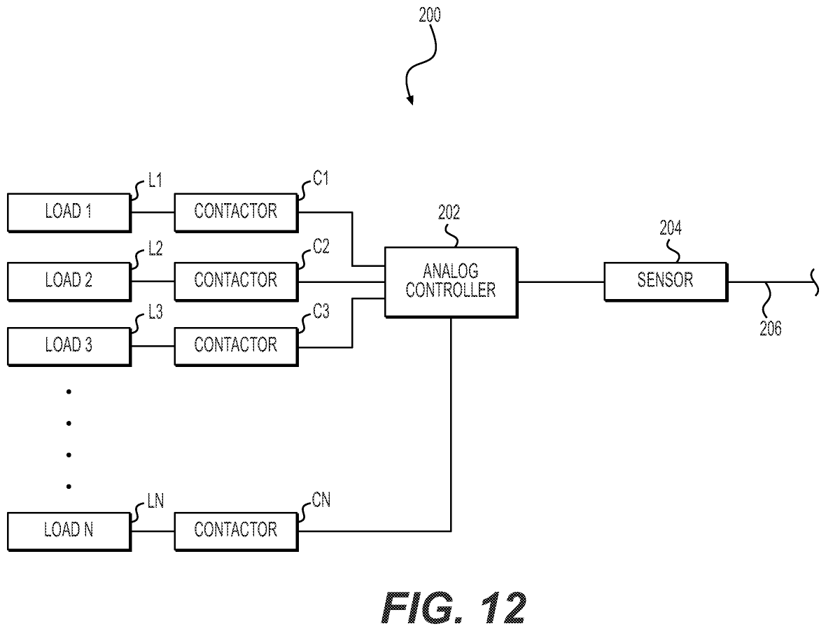

In the alternative embodiment of FIG. 12, an analog control system 200 is shown. Rather than using the control system 10 of the previous embodiment, an analog controller 202 is connected to one or more sensors 204 for monitoring the power coming from the electrical grid 206. It should be understood that sensors 204 may be any suitable type of line meters, monitors or the like for detecting a change in power conditions. Analog controller 202 is set by the user through analog controls, such as switches, knobs, sliders or the like, to disconnect certain ones of loads L1, L2, L3, . . . , LN when sensors 204 detect a pre-set condition (e.g., a brownout, a blackout, a particular power or environmental condition, etc.). During such conditions, an alternative source of power can supply power to desired ones of loads L1, L2, L3, . . . , LN, and non-essential and/or non-desired ones of the loads can be disconnected to save power from the alternative source of power. In the non-limiting example of FIG. 12, the alternative source of power is shown as being a backup power supply 208, however, it should be understood that any suitable type of alternative source of power may be connected, including, but not limited to, solar power, battery power, wind power, and the like.

In FIG. 12, individual contactors C1, C2, C3, . . . , CN are shown respectively connected to loads L1, L2, L3, . . . , LN for the disconnection or shedding of selected ones of the loads, although it should be understood that any suitable type of contactor, switch, circuit or the like may be used to temporarily disconnect or shed a load. It should be understood that analog controller 202 may be any suitable type of circuit, circuitry, circuit module or the like for actuating contactors C1, C2, C3, . . . , CN or the like upon detection of a pre-set condition from sensors 204. Further, it should be understood that analog controller 202 may incorporate the circuitry for automatically switching to alternative power from the alternative source of power upon detection of the pre-set condition from sensors 204.

It should be understood that the block diagram of FIG. 12 is simplified for purposes of illustration. In practice, the power supplied to the loads L1, L2, L3, . . . , LN passes through the analog controller 202 (or through adjacent operated switches or the like) via any suitable type of power lines, with or without additional circuitry, interfaces or the like. In operation, in a manner similar to the previous embodiment, based on the monitoring of sensors 204, analog controller 202 operates contactors C1, C2, C3, . . . , CN (or any other suitable type of switches or the like) to disconnect or reconnect any incoming power (e.g., from the grid through line 206 or from the alternative source of power) and also disconnect or reconnect any of the managed loads L1, L2, L3, . . . , LN. It should be understood that sensors 204 are not limited to only monitoring the power coming through line 206, but may also monitor any desired external parameters or any additional sources of power. Further, it should be understood that controller 202 may receive power from any suitable type of power source, including, but not limited to, the electrical grid through line 206, a storage battery, an alternative source of power or the like.

As a non-limiting example of the above, sensors 204 may measure an increase in power generated by a set of solar panels (indicative of the rising of the sun, in this example), and analog controller 202 could be set to close the contactor associated with a pool pump upon such a detection. Thus, under this pre-set condition, the pool pump is set to run based on the user's knowledge that it will be running on solar power. The analog controller 202 could also be set to switch off the power coming from the electrical grid based on this same condition, ensuring that the pool pump, under this particular condition, will run purely on solar power. In a continuation of this non-limiting example, if measured voltage from the solar panels drops below a pre-set threshold (indicating the sun going down), analog controller 202 could be set to reconnect to the electrical grid based on this measured condition, providing power from the electrical grid to power the pool pump. When the measured voltage from the solar panels goes below this threshold or a secondary threshold, analog controller 202 can be set to disconnect the solar power for the safety of the attached loads. It should be understood that analog controller 202 does not necessarily fully disconnect from the electrical grid; i.e., controller 202 may operate to switch power from a selected power source for individual ones of the loads.

Thus, in the above example, although the pool pump is disconnected from the electrical grid, other appliances and loads do not have to be.

Thus, in general, in the embodiment of FIG. 12, analog controller 202 provides for the management of the plurality of loads L1, L2, L3, . . . , LN connected to both the electrical grid (via line 206) and an alternative source of power (backup power supply 208 in the non-limiting example of FIG. 12). Upon detection of a predetermined condition (e.g., a blackout, a brownout, an environmental condition, etc.) via one or more sensors 204, a user-defined sub-set of the electrical loads L1, L2, L3, . . . , LN may be disconnected from the electrical grid. It should be understood that the sub-set of the electrical loads L1, L2, L3, . . . , LN may include anywhere between one selected load and all of the loads. Additionally, in response the detection of the predetermined condition by sensors 204, at least one of the electrical loads from the user-defined sub-set of the electrical loads may be connected to an alternative source of power, which is not limited to the backup power supply 208 in the non-limiting example of FIG. 12, and may, for example, solar power, wind power, a storage battery, etc. It should be understood that the number of electrical loads from the sub-set which are reconnected to the alternative source of power is user-selected and may be anywhere between a single one of the loads contained in the sub-set and all of the loads contained in the sub-set.

It is to be understood that the energy management system and method is not limited to the specific embodiments described above but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A method for managing energy consumption, comprising the steps of:
prioritizing a group of electrical loads;
receiving one or more energy-related goals, wherein the one or more energy-related goals includes at least one energy-related parameter;
monitoring energy consumption of each of the electrical loads in the group of electrical loads; and
disconnecting at least one lowest ranked one of the electrical loads when the monitored energy consumption deviates from the one or more energy-related goals.

2. The method for managing energy consumption as recited in claim 1, wherein the step of receiving the one or more energy-related goals comprises receiving the one or more energy-related goals as input from a user.

3. The method for managing energy consumption as recited in claim 2, wherein the user inputs the at least one energy-related parameter using a sliding controller on a user interface.

4. The method for managing energy consumption as recited in claim 1, wherein the step of prioritizing the group of electrical loads comprises receiving rankings of the electrical loads input by a user.

5. The method for managing energy consumption as recited in claim 1, wherein the step of prioritizing the group of electrical loads comprises receiving rankings of the electrical loads from a learning-based artificial intelligence system.

6. The method for managing energy consumption as recited in claim 1, wherein the at least one energy-related parameter is selected from the group consisting of time of use-related expenses, energy demand-related expenses, overall average energy expenses, and combinations thereof.

7. The method for managing energy consumption as recited in claim 1, further comprising the step of connecting the group of electrical loads to an alternative source of energy.

8. The method for managing energy consumption as recited in claim 7, wherein the at least one energy-related parameter is selected from the group consisting of average energy exported to an electrical grid from the alternative source of energy, average battery charge time, battery charge level, average battery discharge rate, peak battery discharge rate, battery life, generator run time, remaining fuel level, peak energy, average available energy, and combinations thereof.

9. The method for managing energy consumption as recited in claim 7, further comprising the step of controlling an amount of energy exported from the alternative source of energy to an electrical grid.

10. The method for managing energy consumption as recited in claim 1, further comprising the steps of:
connecting the group of electrical loads to at least one alternative source of energy; and
managing the group of electrical loads and the at least one alternative source of energy to prevent an overload state in the at least one alternative source of energy.

11. The method for managing energy consumption as recited in claim 1, further comprising the step of connecting the group of electrical loads to at least one energy storage device.

12. The method for managing energy consumption as recited in claim 11, further comprising the step of periodically charging the at least one energy storage device.

13. The method for managing energy consumption as recited in claim 12, further comprising the step of determining a performance-related parameter of the at least one energy storage device.

14. The method for managing energy consumption as recited in claim 1, further comprising the steps of:
monitoring at least one external parameter; and
adjusting at least one operational parameter of at least one of the electrical loads based on the at least one external parameter.

15. An energy management system, comprising:
a group of electrical loads; and
a controller configured to:
prioritize a group of electrical loads;
receive one or more energy-related goals, wherein the one or more energy-related goals includes at least one energy-related parameter;
monitor energy consumption of each of the electrical loads in the group of electrical loads; and
disconnect at least one lowest ranked one of the electrical loads when the monitored energy consumption deviates from the one or more energy-related goals.

16. The energy management system as recited in claim 15, further comprising a user interface configured to receive, as input from a user, the one or more energy-related goals.

17. The energy management system as recited in claim 16, wherein the user interface is further configured to display a sliding controller for receiving, as input from the user, the at least one energy-related parameter.

18. The energy management system as recited in claim 15, wherein the at least one energy-related parameter is selected from the group consisting of time of use-related expenses, energy demand-related expenses, overall average energy expenses, and combinations thereof.

19. The energy management system as recited in claim 15, further comprising an alternative source of energy connected to the group of electrical loads.

20. The energy management system as recited in claim 19, wherein the at least one energy-related parameter is selected from the group consisting of average energy exported to an electrical grid from the alternative source of energy, average battery charge time, battery charge level, average battery discharge rate, peak battery discharge rate, battery life, generator run time, remaining fuel level, peak energy, average available energy, and combinations thereof.

21. The energy management system as recited in claim 19, wherein the controller is further configured to control an amount of energy exported from the alternative source of energy to an electrical grid

22. The energy management system as recited in claim 15, further comprising at least one alternative source of energy connected to the group of electrical loads, wherein the controller is further configured to manage the group of electrical loads and the at least one alternative source of energy to prevent an overload state in the at least one alternative source of energy.

23. The energy management system as recited in claim 15, further comprising at least one energy storage device connected to the group of electrical loads.

24. The energy management system as recited in claim 15, further comprising at least one sensor for monitoring at least one external parameter, wherein the controller is further configured to adjust at least one operational parameter of at least one of the electrical loads based on the at least one external parameter.

25. A method of managing power supplies, comprising the steps of:
providing a plurality of electrical loads connected to an electrical grid;
disconnecting a user-defined sub-set of the electrical loads from the electrical grid upon detection of a predetermined condition; and
connecting at least one of the electrical loads from the user-defined sub-set of the electrical loads to an alternative source of power.
